(19) United States
(12) Patent Application Publication
(10) Pub. No.: US 2010/0023998 A1
(43) Pub. Date: Jan. 28, 2010

(54) METHOD, ENTITY AND SYSTEM FOR REALIZING NETWORK ADDRESS TRANSLATION

(75) Inventors: Ting Zou, Shenzhen (CN); Zhenjian Zheng, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/567,424

(22) Filed: Sep. 25, 2009

Related U.S. Application Data
(63) Continuation of application No. PCT/CN2008/071311, filed on Jun. 13, 2008.

(30) Foreign Application Priority Data
Jun. 15, 2007 (CN) 200710118990.9
Jul. 20, 2007 (CN) 200710130171.6

(51) Int. Cl. G06F 17/00

(52) U.S. Cl. 726/1; 709/246

(57) ABSTRACT

A method of realizing network address translation (NAT) includes the following steps. An application function (AF) entity receives a message, and determines a signaling direction according to the message. The AF entity carries the signaling direction information in an access authorization request (AAR) message and sends the AAR message to a service-based policy decision function (SPDF) entity. The SPDF entity obtains a corresponding local domain address according to the signaling direction, and sends the obtained address to the AF entity. The AF entity sends the message according to the local domain address. An entity and a system of realizing NAT are also provided. By extending a message interacted between the AF entity and the SPDF entity and adding a field indicating a signaling direction, the SPDF entity is enabled to distinguish an uplink direction or a downlink direction of the message, for example, from an access side/a local core side to a core side/an opposite core side or from the core side/opposite core side to the access side/local core side, so as to realize an NAT control.

### CROSS-REFERENCE TO RELATED APPLICATIONS

This application is a continuation of International Application No. PCT/CN2008/071311, filed on Jun. 13, 2008, which claims priority to Chinese Patent Application Nos. 200710118990.9, filed on Jun. 15, 2007, and 200710130171.6, filed on Jul. 20, 2007; both of which are hereby incorporated by reference in their entireties.

### FIELD OF THE TECHNOLOGY

The present invention relates to communication technology, and more particularly to a method, an entity, and a system for realizing network address translation (NAT).

### BACKGROUND OF THE INVENTION

As Internet has been widely applied, various types of network services emerge one after another, and advanced multimedia communication systems are continuously proposed. As real-time services are sensitive to characteristics like the network transmission delay and delay variation, if File Transfer Protocol (FTP) services or Hypertext Transfer Protocol (HTTP) services with image files that have high burst characteristics exist in the network, the real-time services may be seriously affected. Furthermore, since the multimedia services occupy a large bandwidth, critical services that need to be guaranteed in the existing network may be difficult to be transmitted reliably. Therefore, various quality of service (QoS) techniques are proposed to solve the above problems.

Ethernet and end to end Ethernet techniques enjoy high cognition among operators and users in enterprises and public institutions. The Ethernet technique is one of the main techniques for constructing triple play and Metropolitan Area Network (MAN) in the future, and Ethernet services may be developed dramatically in the future market.

In view of the above, in a next generation network (NGN) (a packet network architecture of ETSI TISPAN), a resource admission control subsystem (RACS) is introduced between an application layer and a transport layer and is responsible for uniform management of bearer network resources, and providing policy-based control, including QoS and network address translation (NAT) of the bearer network that all need to be accessed and controlled via the RACS. The RACS architecture defined in the NGN is shown in FIG. 1.

The RACS mainly includes a service-based policy decision function (SPDF) entity and an access-resource admission control function (A-RACF). The other parts of FIG. 1 demonstrate relations and interfaces between relevant functional entities and the RACS architecture. An application function (AF) entity interacts with the SPDF entity via a Gq′ interface, and transmits information about session services. The AF entity may be specifically a proxy-call session control function (P-CSCF) or an interconnect border control function (IBCF). A border gateway function (BGF) and a resource control enforcement function (RCEF) are policy enforcement points (PEPs) on the transport layer. The SPDF entity mainly interacts with the BGF, so as to instruct the BGF to implement QoS control policy and/or NAT control.

The NAT solves the problem about address conflict by substituting an unregistered address written in an IP packet with a legal and registered IP address. That is, internal addresses are used in an internal network, and the NAT translates the internal addresses into legal IP addresses for being used in the Internet. During the NAT, the addresses in the IP packet are substituted by legal IP addresses, so as to enable plenty of internal hosts to access the Internet via a few IP addresses.

However, during the implementation of the present invention, the inventors found the following disadvantages.

According to the current RACS standard, when one traffic flow contains an uplink media stream and a downlink media stream, and in the case of interworking between an IP multimedia subsystem (IMS) network and certain conventional networks such as a public switched telephone network (PSTN), the SPDF entity cannot distinguish a direction of a current session description protocol (SDP), and thus cannot perform an NAT control.

### SUMMARY OF THE INVENTION

Accordingly, the present invention is directed to a method, an entity, and a system for realizing network address translation (NAT), so as to solve the problem in the prior art that a service-based policy decision function (SPDF) entity cannot distinguish a direction of a current session description protocol (SDP) and thus cannot perform an NAT control.

The present invention is accomplished by the following technical solutions.

In an embodiment, the present invention provides a method for realizing NAT, which includes the following steps.

An application function (AF) entity receives a message, and determines a signaling direction according to the message.

The AF entity sends an access authorization request (AAR) message to an SPDF entity, where the AAR message carries signaling direction information indicating the signaling direction.

The AF entity sends the message according to a local domain address corresponding to the signaling direction returned from the SPDF entity.

In an embodiment, the present invention further provides an AF entity, which includes a signaling direction indication module, an NAT module, and a message forwarding module.

The signaling direction indication module is adapted to receive a message, determine a signaling direction according to the message, carry signaling direction information indicating the signaling direction in an AAR message, and send the AAR message.

The NAT module is adapted to perform substitutions between an access-side local domain address/a local-core-side address and a core-side local domain address/an opposite-core-side address according to a local domain address obtained and sent by an SPDF entity.

The message forwarding module is adapted to forward the message according to an address obtained by the NAT module after performing the address substitution.

In an embodiment, the present invention further provides an SPDF entity, which includes a message acquisition module and an NAT control module.

The message acquisition module is adapted to receive an AAR message carrying signaling direction information indicating a signaling direction sent from an AF entity.

The NAT control module is adapted to obtain a local domain address according to the signaling direction and send the obtained address to the AF entity, so as to realize an NAT control.

In an embodiment, the present invention further provides a system for realizing NAT, which includes an AF entity and an SPDF entity.

The AF entity is adapted to receive a message, determine a signaling direction according to the message, send an AAR message carrying signaling direction information indicating the signaling direction, receive a local domain address corresponding to the message, and forward the message according to the local domain address.

The SPDF entity is adapted to receive the AAR message carrying the signaling direction sent from the AF entity, obtain the local domain address according to the signaling direction, and send the obtained local domain address to the AF entity.

As seen from the technical solutions provided in the embodiments of the present invention, by extending messages interacted between the AF entity and the SPDF entity and adding a field indicating a signaling direction, the SPDF entity is enabled to distinguish an uplink direction or a downlink direction of the message, in which the uplink direction is, for example, from an access side to a core side or from a local core side to an opposite core side, or the downlink direction is, for example, from the core side to the access side or from the opposite core side to the local core side, so as to realize an NAT control.

### BRIEF DESCRIPTION OF THE DRAWINGS

FIG. 1 is an architectural diagram of an RACS defined in an NGN according to the prior art;

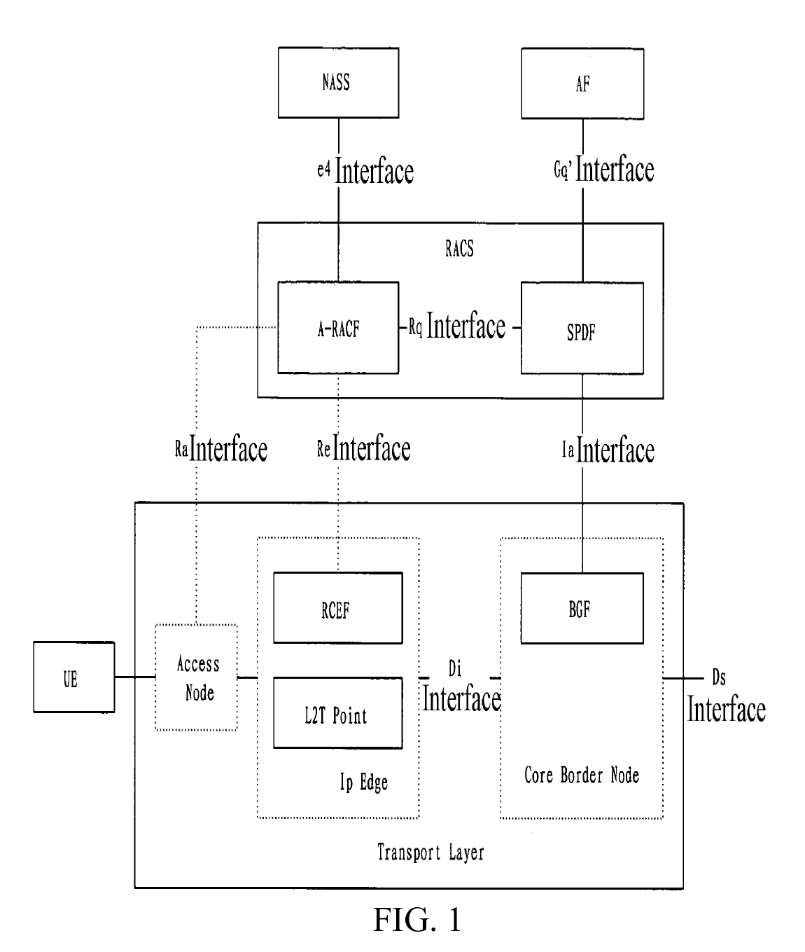

FIG. 2 is a schematic diagram of an SDP Direction AVP message in the case of IBCF networking according to an embodiment of the present invention;

FIG. 3 is a flow chart of a first embodiment of the present invention;

FIG. 4 is a flow chart of a second embodiment of the present invention;

FIG. 5 is a flow chart of realizing an NAT control at a calling party in the case of IBCF networking according to an embodiment of the present invention;

FIG. 6 is a flow chart of realizing an NAT control at a called party in the case of IBCF networking according to an embodiment of the present invention; and

FIG. 7 is a schematic diagram of a system according to a third embodiment of the present invention.

### DETAILED DESCRIPTION OF THE EMBODIMENTS

The technical solutions of the present invention are clearly and completely described as follows with reference to the accompanying drawings. Apparently, the embodiments to be described are only a part rather than all of the embodiments of the present invention. All other embodiments obtained by persons skilled in the art based on the embodiments of the present invention without creative efforts shall fall within the protection scope of the present invention.

In the embodiments of the present invention, by extending an interface between two entities and adding a field indicating a signaling direction in a message of the interface, in which the field indicating the signaling direction carries the signaling direction information, a message receiver is enabled to rapidly and explicitly identify the signaling direction according to the signaling direction information carried in the field indicating the signaling direction, so as to realize an NAT control and other operations.

The two entities may be an AF entity and an SPDF entity.

In the following embodiments, two entities, AF entity and SPDF entity, in the IMS are taken as an example for illustration, in which a Session Initiation Protocol (SIP) is, for example, adopted between the two entities. By extending an interface Gq′ between the AF entity and the SPDF entity and adding a field indicating an SDP direction, that is, an SDP Direction attribute-value pair (AVP), in an AAR message at the Gq′, the SPDF entity is enabled to distinguish an uplink direction or a downlink direction of the SDP, so as to realize an NAT control.

In an embodiment of the present invention, SDP Direction AVP indicating the SDP direction is added at the interface Gq′ between the AF entity and the SPDF entity, and the AAR message is defined as follows:

<AA-Request> ::= < Diameter Header: 265, REQ, PXY >

```
  < Session-Id > (Session ID)
  { Auth-Application-Id } (Application ID)
  { Origin-Host } (Origin host)
  { Origin-Realm } (Origin realm)
  { Destination-Realm } (Destination realm)
  [SDP Direction] (SDP direction)
*[ Media-Component-Description ] (Media component
```

description)

```
  *[ Flow-Grouping ] (Flow grouping)
  [ AF-Charging-Identifier ] (AF charging identifier)
  [ SIP-Forking-Indication ] (SIP forking indication)
*[ Specific-Action ] (Specific action)
  [ User-Name ] (User name)
  [ Binding-Information ] (Binding information)
  [ Latching-Indication ] (Latching indication)
  [ Reservation-Priority ] (Reservation priority)
  [ Globally-Unique-Address ] (Globally unique address)
  [ Authorization-Lifetime ] (Authorization lifetime)
*[ Proxy-Info ] (Proxy information)
*[ Route-Record ] (Route record)
*[ AVP ] (Other AVPs)
```

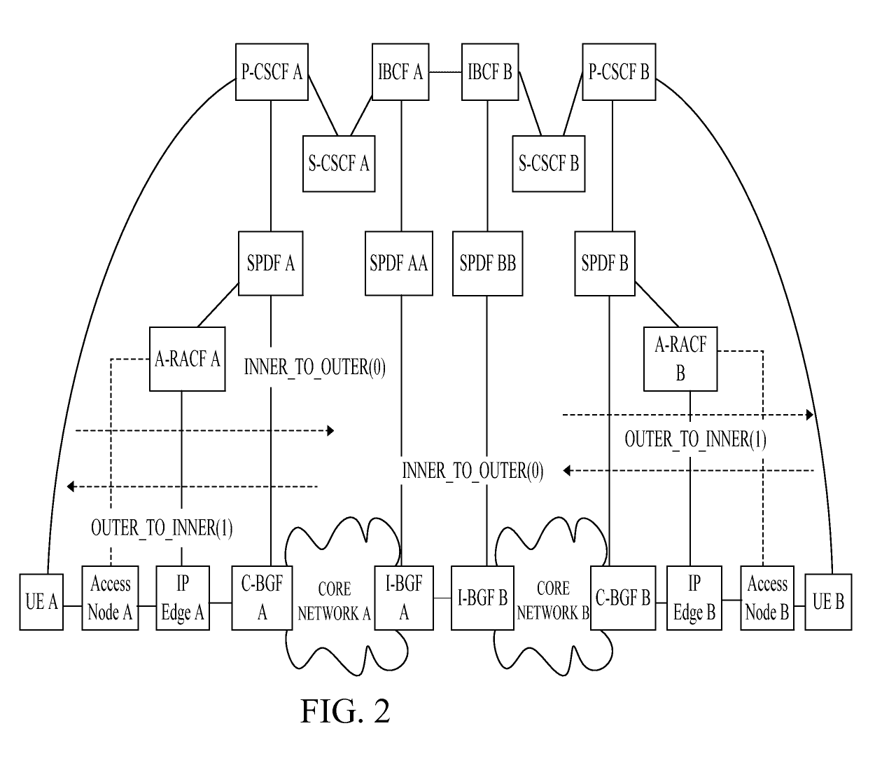

In the above defined AAR message, [SDP Direction] is corresponding to the SDP Direction AVP, and a format of the SDP Direction AVP may be a 32-bit integer. Referring to FIG. 2, when the SDP Direction AVP is configured for an NAT control in the case of IBCF networking, the SDP Direction AVP may be defined as follows:

INNER TO_OUTER(0): indicating a direction from an access side to a core side or from a local core side to an opposite core side.

OUTER TO_INNER(1): indicating a direction from the core side to the access side or from the opposite core side to the local core side.

The SDP Direction AVP is applicable to an NAT control and/or QoS resource reservation scenario.

The applications of the SDP Direction AVP are illustrated in detail as follows through different embodiments.

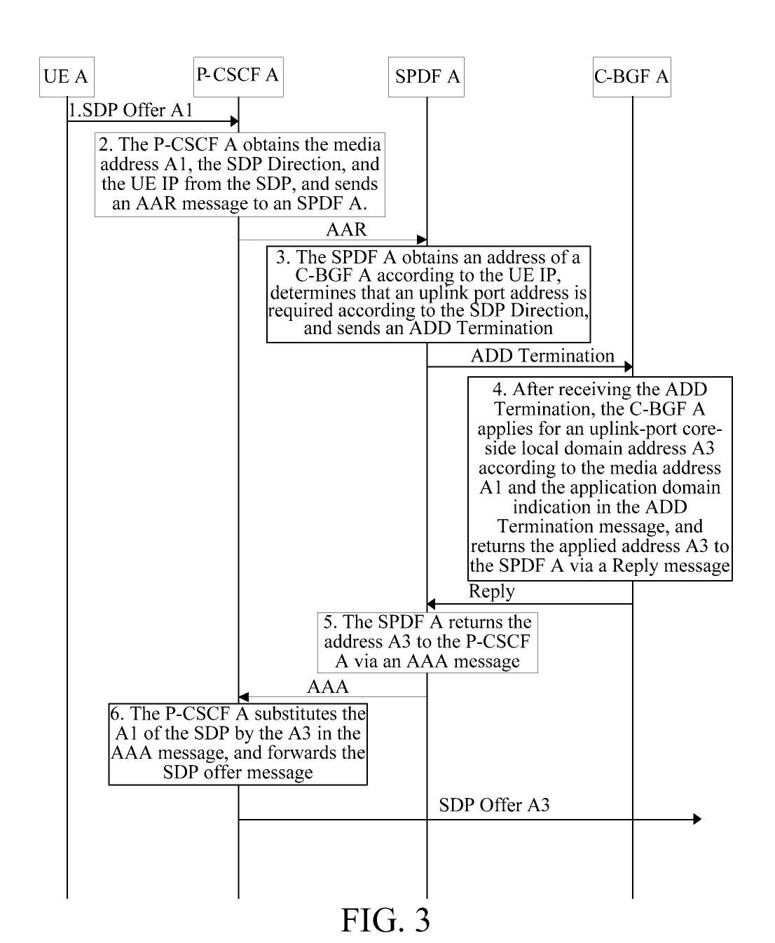

In a first embodiment, the present invention provides a method for realizing an NAT control by using an SDP direction. Referring to FIG. 3, a method for realizing an NAT control by a calling party is shown, in which an IBCF networking scenario does not exist, the AF entity is specifically a P-CSCF, and the calling party is set to be a user entity A, that is, UE A. The method mainly includes the following steps.

In Step 1, a P-CSCF A receives an SDP offer message (offering an SDP message configuration) sent from the UE A.

The SDP offer message may be carried in a message such as an INVITE request, and include a group of media streams and codes expected to be used by a message sender (the UE A at an access end), an IP address and a port number through which a message expected to be received by the message sender, and an IP address of the access end. Particularly, the SDP offer message may include an IP address and a port number through which a message (for example, a media stream) expected to be received. For example, the message may carry a media address A1, an SDP Direction (INNER TO_OUTER(0): entering an IMS core domain), and an IP address of the UE A, in which “entering the IMS core domain” indicates a direction from the access side to the core side.

Regarding a message sent from the UE A to a core-network side, the media address serves as a destination address of the message for the UE A side, and serves as a source address of the message for the core-network side.

In Step 2, the P-CSCF A obtains the media address A1, the SDP Direction (INNER_TO_OUTER(O): entering the IMS core domain), and the IP address of the UE A from the received SDP offer message, and then sends an AAR message to an SPDF A.

The content carried by the AAR message may be obtained with reference to the above definition of the AAR message.

In Step 3, after receiving the AAR message, the SPDF A searches for a local route according to the IP address of the UE A, obtains an address of a C-BGF A (a core-BGF corresponding to the UE A side) corresponding to the IP address of the UE A, and obtains a value of the SDP Direction carried in the AAR message, in which the value is INNER_TO_OUTER(O), so that the SPDF A determines that it requires to apply for an uplink port address of a media stream (that is, a core-side address). Therefore, the SPDF A sends an ADD Termination (a local domain address request) message to the C-BGF A, and applies for an allocation of an uplink port address of a media stream.

The ADD Termination message carries the media address A1 of the SDP offer message and an application domain indication (indicating that it applies for an access-side local domain address or a core-side local domain address).

In Step 4, after receiving the ADD Termination message, the C-BGF A applies for an uplink-port core-side local domain address A3 according to the media address A1 and the application domain indication in the ADD Termination message, and returns the applied address A3 to the SPDF A via a Reply message.

In Step 5, the SPDF A returns the address A3 to the P-CSCF A via an AA-Answer (AAA) message.

In Step 6, the P-CSCF A substitutes the original address A1 of the SDP by the address A3 in the AAA message, and forwards the SDP offer message to a called party.

The first embodiment describes an initial creating process of media mapping for the calling party. In the process, the P-CSCF carries a value of the SDP Direction in an AAR message, and the SPDF entity is enabled to determine whether the message is sent to a core side or an access side, so as to request and obtain a local domain address. Afterwards, the SPDF entity notifies the P-CSCF about the local domain address, and the P-CSCF forwards the message according to the local domain address, thereby realizing an NAT control of the calling party.

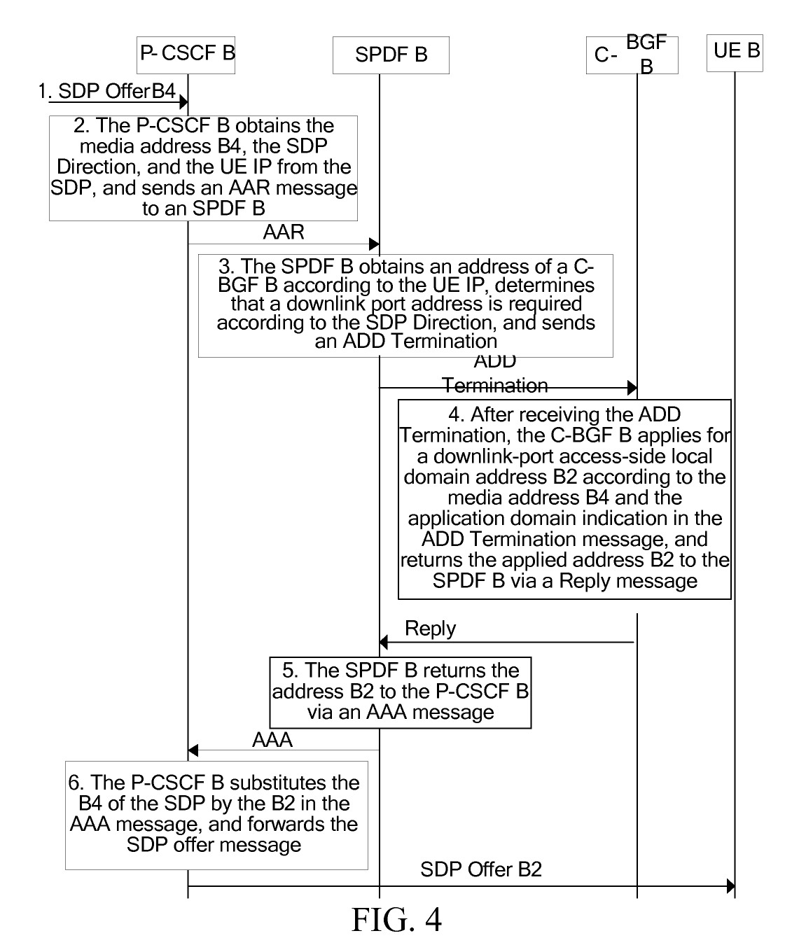

In a second embodiment, the present invention provides a method for realizing an NAT control by using an SDP direction. Referring to FIG. 4, a method of realizing an NAT control by a called party is shown, in which an IBCF networking scenario does not exist, the AF entity is specifically a P-CSCF, and the called party is set to be a user entity B, that is, UE B. The method mainly includes the following steps.

In Step 1, a P-CSCF B receives an SDP offer message carrying a media address B4.

The SDP offer message may be carried in a message such as an INVITE request, and include a group of media streams and codes expected to be used by a message sender, an IP address and a port number through which a message expected to be received by the message sender, and an IP address of an access end. For example, the message may carry the media address B4, an SDP Direction (OUTER_TO_INNER (1): exiting an IMS core network), and an IP address of the UE B, in which “exiting the IMS core network” indicates a direction from a core side to an access side.

Regarding a message sent from a core-network side to the UE B, the media address serves as a destination address of the message for the core-network side, and serves as a source address of the message for the UE B side.

In Step 2, the P-CSCF B obtains the media address B4, the SDP Direction (OUTER TO_INNER (1): exiting the IMS core network), and the IP address of the UE B from the received SDP offer message, and then sends an AAR message to an SPDF B.

In Step 3, after receiving the AAR message, the SPDF B searches for a local route according to the IP address of the UE B, obtains an address of a C-BGF B (a core-BGF corresponding to the UE B side), and obtains a value of the SDP Direction carried in the AAR message, in which the value of the SDP Direction is OUTER_TO_INNER (1), so that the SPDF B determines that it requires to apply for a downlink port address (that is, an access-side address) of a media stream. Therefore, the SPDF B sends an ADD Termination message to the C-BGF B, and applies for an allocation of a downlink port address of a media stream.

The ADD Termination message carries the media address B4 of the SDP offer message and an application domain indication (indicating it applies for an access-side local domain address or a core-side local domain address).

In Step 4, the C-BGF B applies for a downlink-port access-side local domain address B2 according to the media address B4 and the application domain indication in the ADD Termination message, and returns the applied address B2 to the SPDF B via a Reply message.

In Step 5, the SPDF B returns the address B2 to the P-CSCF B via an AAA message.

In Step 6, the P-CSCF B substitutes the original address B4 of the SDP by the address B2 in the AAA message, and forwards the SDP offer message to the access-side UE B.

The second embodiment describes an initial creating process of media mapping for the called party. In the process, the P-CSCF carries the SDP Direction in an AAR message, so that the SPDF entity is enabled to determine whether the message is sent to a core side or an access side, so as to request and obtain a local domain address. Afterwards, the SPDF entity notifies the P-CSCF about the local domain address, and the P-CSCF forwards the message according to the local domain address, thereby realizing an NAT control of the called party.

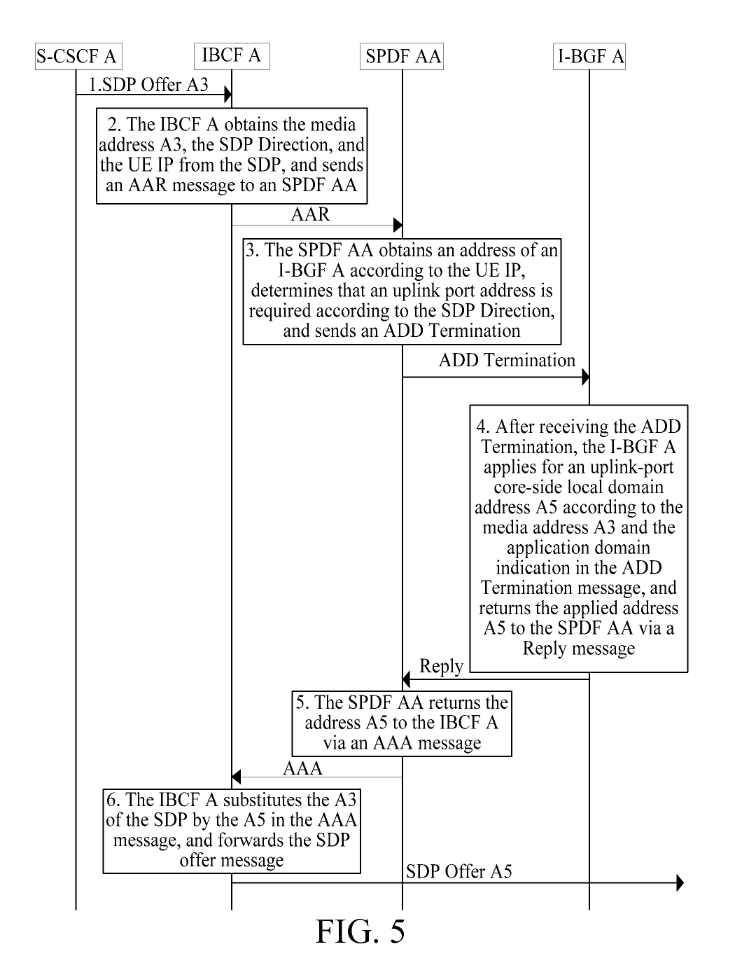

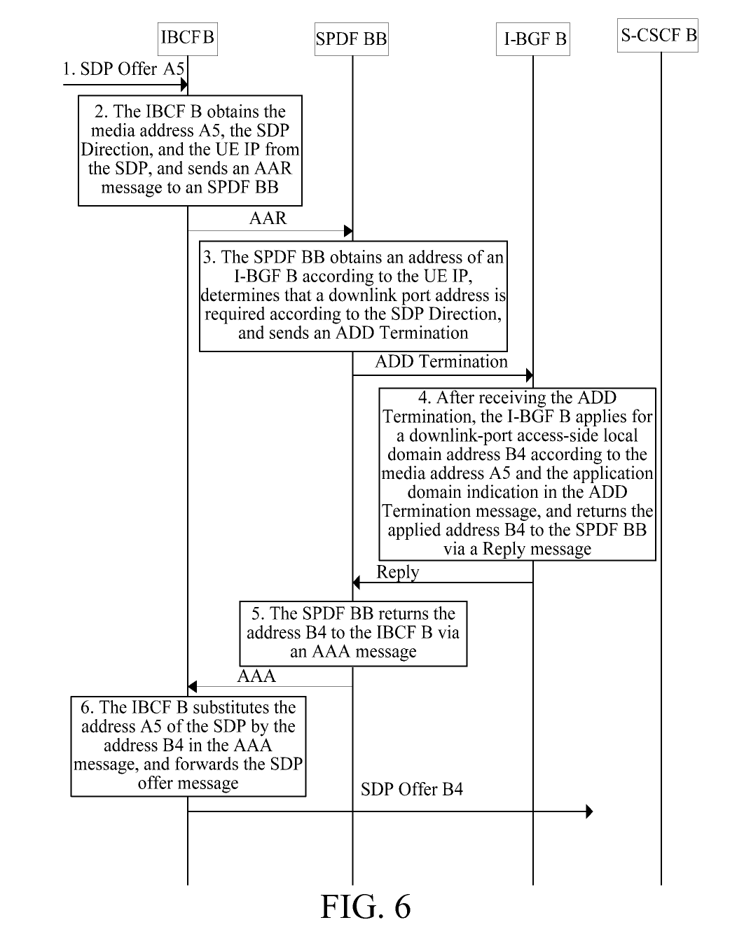

In the above embodiments, two methods of realizing an NAT control are provided in the case of no IBCF networking. When the IBCF networking exists, it is different from the above embodiments in the following aspects. The P-CSCF firstly forwards a corresponding message to a serving-CSCF (S-CSCF), and the S-CSCF forwards the message to the IBCF. Next, the IBCF sends a message carrying an SDP Direction to a local SPDF AA or SPDF BB connected to the IBCF, and then the SPDF AA or SPDF BB interacts with a corresponding interconnect-BGF (I-BGF) to obtain a local address. Then, the SPDF AA or SPDF BB notifies the IBCF about the local address, and then the IBCF forwards the message according to the local address, so as to realize an NAT control. A corresponding process of realizing an NAT control at a calling party in the case of IBCF networking is shown in FIG. 5, and a corresponding process of realizing an NAT control at a called party in the case of IBCF networking is shown in FIG. 6, so that the detailed processes thereof are not given herein again.

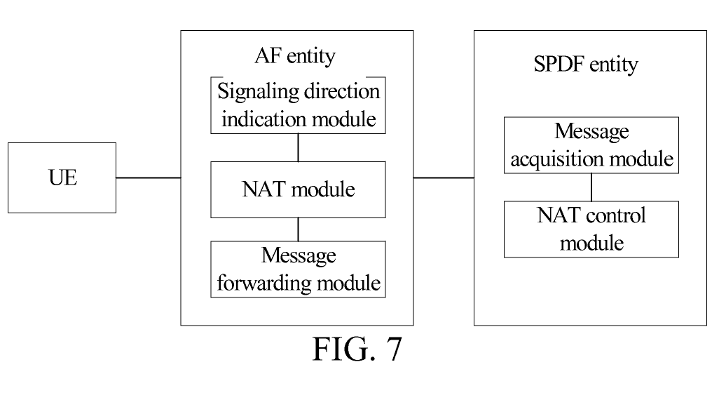

In a third embodiment, the present invention provides a system of realizing an NAT control by using an SDP direction. FIG. 7 is a structural view of the system. Referring to FIG. 7, the system includes a UE, an AF entity, and an SPDF entity.

The AF entity is adapted to receive a message sent from the UE, determine a signaling direction according to the message, and send an AAR message to the SPDF entity where the AAR message carries signaling direction information indicating the signaling direction. The AF entity is also adapted to receive a local domain address corresponding to the message sent from the SPDF entity, and forward the message according to the local domain address.

To achieve the above functions, the AF entity at least includes a signaling direction indication module, an NAT module, and a message forwarding module.

The signaling direction indication module is adapted to receive a message sent from the UE, determine a signaling direction according to the message, carry the signaling direction information in an AAR message, and send the AAR message.

The NAT module is adapted to perform substitutions between an access-side local domain address/local-core-side address and a core-side local domain address/opposite-core-side address (that is, substitutions between an access-side local domain address and a core-side local domain address or between a local-core-side address and an opposite-core-side address) according to a local domain address obtained and sent by the SPDF entity.

The message forwarding module is adapted to forward the message according to the address obtained by the NAT module after performing the address substitution.

The AF entity may be a P-CSCF or an IBCF.

The SPDF entity is adapted to receive the AAR message carrying the signaling direction sent from the AF entity, and realize an NAT control according to the signaling direction. To achieve the above functions, the SPDF entity at least includes a message acquisition module and an NAT control module.

The message acquisition module is adapted to receive the AAR message carrying the signaling direction information sent from the AF entity.

The NAT control module is adapted to realize an NAT control according to the signaling direction information. The NAT control mainly includes determining a required local domain address according to the signaling direction, and sending the address to the AF entity.

In the embodiments of the present invention, a method of determining a signaling direction when the SIP is adopted in the interworking between the IMS network and other networks is mainly introduced, and the method is also applicable to the determination of a signaling direction in the case of interworking between other networks.

In view of the above, according to the embodiments of the present invention, by extending an interface between the AF entity and the SPDF entity and adding an SDP Direction AVP indicating the signaling direction in the AAR message, the SPDF entity is enabled to distinguish an uplink direction or a downlink direction of the SDP, so as to realize an NAT control. Besides, in the case of interworking between an IMS network and certain conventional networks such as a PSTN, or when an upstream or a downstream of a media stream passes through the uplink/downlink port of the BGF at the same time, the SPDF entity is enabled to distinguish the current direction of the SDP is from an access side/local core side to a core side/opposite core side or from the core side/opposite core side to the access side/local core side, so as to realize an NAT control. The direction from the access side/local core side to the core side/opposite core side indicates a direction from the access side to the core side or from the local core side to the opposite core side. The direction from the core side/opposite core side to the access side/local core side indicates a direction from the core side to the access side or from the opposite core side to the local core side.

The above descriptions are merely several embodiments of the present invention, but not intended to limit the present invention. Any modification, equivalent replacement, and improvement made without creative efforts shall fall within the protection scope of the present invention.

What is claimed is:

1. A method for realizing network address translation (NAT), comprising:
receiving, by an application function (AF) entity, a message and determining a signaling direction according to the message;
sending, by the AF entity, an access authorization request (AAR) message to a service-based policy decision function (SPDF) entity, wherein the AAR message carries signaling direction information indicating the signaling direction; and
sending, by the AF entity, the message according to a local domain address corresponding to the signaling direction returned from the SPDF entity.

2. The method according to claim 1, further comprising:
obtaining, by the SPDF entity, the signaling direction information from the message sent by the AF entity, obtaining the corresponding local domain address according to the signaling direction information, and sending the obtained local domain address to the AF entity.

3. The method according to claim 2, wherein the message received by the AF entity comprises:
a media address, the signaling direction information indicating the signaling direction, and an IP address of an access end.

4. The method according to claim 3, wherein the obtaining, by the SPDF entity, the corresponding local domain address according to the signaling direction further comprises:
determining, by the SPDF entity, a corresponding border gateway function (BGF) entity according to the IP address of the access end, and determining the required local domain address according to the signaling direction; and
requesting and obtaining, by the SPDF entity, the local domain address from the corresponding BGF entity.

5. The method according to claim 4, wherein the requesting and obtaining, by the SPDF entity, the local domain address from the corresponding BGF entity further comprises:
sending, by the SPDF entity, a local domain address request message carrying the media address and an application domain indication to the BGF entity; and
applying, by the BGF entity, for the corresponding local domain address according to the request message, and returning the applied address to the SPDF entity.

6. The method according to claim 4, wherein when the signaling direction is from an access side to a core side, the local domain address is a core-side local domain address, and when the signaling direction is from the core side to the access side, the local domain address is an access-side local domain address; or
when the signaling direction is from a local core side to an opposite core side, the local domain address is an opposite-core-side address, and when the signaling direction is from the opposite core side to the local core side, the local domain address is a local-core-side address.

7. The method according to claim 5, wherein when the signaling direction is from an access side to a core side, the local domain address is a core-side local domain address, and when the signaling direction is from the core side to the access side, the local domain address is an access-side local domain address; or
when the signaling direction is from a local core side to an opposite core side, the local domain address is an opposite-core-side address, and when the signaling direction is from the opposite core side to the local core side, the local domain address is a local-core-side address.

8. The method according to claim 3, wherein the sending, by the AF entity, the message according to the local domain address further comprises:
substituting, by the AF entity, the media address originally carried in the message by the local domain address, and then sending the message.

9. The method according to claim 4, wherein the sending, by the AF entity, the message according to the local domain address further comprises:
substituting, by the AF entity, the media address originally carried in the message by the local domain address, and then sending the message.

10. An application function (AF) entity, comprising:
a signaling direction indication module, adapted to receive a message, determine a signaling direction according to the message, carry the signaling direction information indicating the signaling direction in an access authorization request (AAR) message, and send the AAR message;
a network address translation (NAT) module, adapted to perform substitutions between an access-side local domain address/a local-core-side address and a core-side local domain address/an opposite-core-side address according to a local domain address obtained and sent by a service-based policy decision function (SPDF) entity; and
a message forwarding module, adapted to forward the message according to the address obtained by the NAT module after performing substitution.

11. The AF entity according to claim 10, wherein the AF entity is a proxy-call session control function (P-CSCF) or an interconnect border control function (IBCF).

12. A service-based policy decision function (SPDF) entity, comprising:
a message acquisition module, adapted to receive an access authorization request (AAR) message carrying signaling direction information indicating a signaling direction sent from an application function (AF) entity; and
a network address translation (NAT) control module, adapted to obtain a local domain address according to the signaling direction and send the obtained address to the AF entity, so as to realize a NAT control.

13. A system for realizing network address translation (NAT), comprising:
an application function (AF) entity, adapted to receive a message, determine a signaling direction according to the message, send an access authorization request (AAR) message carrying signaling direction information indicating the signaling direction, receive a local domain address corresponding to the message, and forward the message according to the local domain address; and
a service-based policy decision function (SPDF) entity, adapted to receive the AAR message carrying the signaling direction sent from the AF entity, obtain the local domain address according to the signaling direction, and send the local domain address.
